(19) United States
(12) Patent Application Publication
(10) Pub. No.: US 2026/0108331 A1
(43) Pub. Date: Apr. 23, 2026

(54) SYSTEM AND METHOD FOR IMPROVED INTRA-ORAL SCANNING PROTOCOL AND IMAGE REGISTRATION

(71) Applicant: BIOMET 3I, LLC, Palm Beach Gardens, FL (US)

(72) Inventors: Zachary B. Suttin, Jupiter, FL (US); Andreas Geier, Gargazon (IT); Werner Weithaler, Burgstall (IT)

(21) Appl. No.: 19/366,005

(22) Filed: Oct. 22, 2025

Related U.S. Application Data
(60) Provisional application No. 63/710,453, filed on Oct. 22, 2024.
(60) Provisional application No. 63/821,974, filed on Jun. 11, 2025.

(51) Int. Cl. A61C 13/00; G06T 7/00; G06T 7/33; G06T 7/55; G06T 17/00

(52) U.S. Cl. CPC A61C 13/0004; G06T 7/0014; G06T 7/337; G06T 7/344; G06T 7/55; G06T 17/00; G06T 2207/30036; G06T 2207/30052; G06T 2210/41

(57) ABSTRACT

The present disclosure is directed to a method and system that receives an intra-oral scanned dataset comprising adjacent first and second scan patches, the adjacent first and second scan patches comprising scanned images of adjacent portions of a depth registration tool engaging first and second dental fixtures positioned on first and second segments, respectively, of a dental arch area and overlaying a soft tissue, homogeneous, cross-arch connecting area between the first and second segments, the first and second scan patches having different background images on the depth registration tool, identifies a raised feature common to the first and second scan patches, and aligns, based on the identified at least one raised feature, the first and second scan patches to form a composite digital image.

### FIELD

This disclosure relates to dental restoration techniques and specifically for obtaining accurate intra-oral scan results for the connecting areas between segments of an arch.

### BACKGROUND

Intra-oral scanning (IOS) has emerged as a preferred dental impression technique for conventional (tooth-borne) and implant dentistry. IOS typically involves using a handheld scanner having optical sensors to capture a three-dimensional dataset of the area of interest. Corresponding software captures all images from the IOS and captures the three-dimensional dataset in real-time, generates, based on the dataset, a three-dimensional model of the area of interest, and sends the dataset to a computer. Using software on the computer, the three-dimensional model may be used to fabricate models of the area or interest for preparation of restoration devices.

The resulting dataset may be used for constructing a model for preparing patient specific prosthetics.

There are many potential contributing factors for the difficulty of applying IOS to full arch restorations. For example, limited depth of view can cause the intra-oral scanner to capture scan bodies but miss key image information during a scan, complicating image reconstruction. The image information can be features positioned lower than the depth of view of the intra-oral scanner. Rather than capturing the image information associated with such features, the intraoral scanner will yield scanned images omitting the features.

While IOS is robust when scanning well defined landmarks (i.e., teeth vs. tissue), large homogeneous areas needed for full arch restoration can be problematic. As an arch is scanned, if there are homogeneous segments, especially large ones, these landmarks are vague and, therefore, cannot be interpreted as accurately. The teeth serve as robust landmarks in a scan of an arch, but soft-tissue surfaces between segments of the arch such as the mouth surfaces and the tongue are homogenous surfaces and are therefore difficult to scan accurately. The connecting area(s) such as the tongue or the roof of the mouth are essentially seen as “oceans” of homogeneous surfaces in the scan dataset in that these homogeneous surfaces are difficult to distinguish from each other because they all appear the same in the scanned dataset. While small adjacent site-to-site errors have minimal impact on single tooth or short-span multiple tooth segments, such errors may accumulate in a full arch scan to an unacceptable level.

The geometry acquired for the cross-arch connecting geometry (i.e., the tongue or the palate) covers a relatively large area, but only a small portion of the data within this area is scanned. This may lead to cross-arch error and/or full arch distortion and is often most visible when assessing the posterior segments of the resulting model, as these zones are adjacent to the greatest area of “digital dead space” (or the space not scanned).

### SUMMARY

These and other needs are addressed by the various embodiments and configurations of the present disclosure.

The present disclosure can include a method of imaging a soft tissue, homogeneous, cross-arch connecting area extending between a dental arch area, the dental arch area comprising opposing first and second segments separated by the soft tissue, homogenous, cross-arch connecting area, that includes the steps of:
receiving an intra-oral scanned dataset comprising adjacent first and second scan patches, the adjacent first and second scan patches comprising scanned images of adjacent portions of a depth registration tool engaging first and second dental fixtures positioned on the first and second segments, respectively, of the dental arch area and overlaying the soft tissue, homogeneous, cross-arch connecting area, the first and second scan patches having different background images of one or more raised features on the depth registration tool;
identifying at least one raised feature of the one or more raised features common to the first and second scan patches; and
aligning, based on the identified at least one raised feature, the first and second scan patches to form a composite digital image.

The present disclosure can include a computational system comprising a processor and computer readable medium comprising instructions that, when executed, cause the processor to:
receive an intra-oral scanned dataset comprising adjacent first and second scan patches, the adjacent first and second scan patches comprising scanned images of adjacent portions of a depth registration tool engaging first and second dental fixtures positioned on first and second segments, respectively, of a dental arch area and overlaying a soft tissue, homogeneous, cross-arch connecting area between the first and second segments, the first and second scan patches having different background images of one or more raised features on the depth registration tool;
identify at least one raised feature of the one or more raised features common to the first and second scan patches; and
align, based on the identified at least one raised feature, the first and second scan patches to form a composite digital image.

The present disclosure can include a depth registration tool for intra-oral scanning that includes:
a plurality of attachment locations distributed around a peripheral edge of the tool and configured to attach to a plurality of dental fixtures positioned on first and second segments, respectively, of a dental arch area; and
a central area configured to overlay a soft tissue, homogeneous, cross-arch connecting area between the first and second segments and comprising a plurality of non-uniformly distributed elevated objects, the non-uniformly distributed elevated objects comprising upper surfaces elevated relative to an adjacent surface of the central area, the central area blocking scanning of at least most of the soft tissue, homogeneous, cross-arch connecting area between the first and second segments.

The present disclosure can include a scan body for intra-oral scanning that includes:
a base configured to attach to a dental fixture;
an upper scan body extending upwardly from the base, the upper scan body comprising a leading surface and a trailing surface, the leading surface having a different shape than the trailing surface, and one or more information markers; and
first and second elongated arms positioned between the base and upper scan body, the first elongated arm extending anteriorly from the leading surface and the second elongated arm extending posteriorly from the trailing surface.

An example of the present disclosure is a method of providing a three-dimensional scan of a dental arch area, the arch area having two segments and a connecting area between the two segments. A depth registration tool comprising a plurality of surface regions, each of which is adjacent to a corresponding scan body, implant, abutment, healing abutment or other dental fixture and a definable feature in an interior portion of the tool is affixed relative to the dental arch area. The definable feature overlays at least part of the connecting area. The arch and arch area are scanned to produce a scanned dataset comprising multiple scan patches. Each of the scan patches has, relative to the other scan patches, a unique background provided by the depth registration tool. The unique background can be used to determine Z-axis positions for the respective scanned objects in each scan patch and/or to align the various scan patches to form a composite digital image. Data relating to the definable feature in the interior portion of the depth registration tool overlaying the connecting area can be determined based on the scanned dataset. The dimensions of the connecting area can in turn be determined based on the data relating to the definable feature.

Another example is a system for producing a scanned dataset of a dental arch area, the dental arch area including two segments and a connecting area between the two segments. The system includes a controller and an intra-oral scanner coupled to the controller. A depth registration tool comprising a plurality of surface regions, each of which is adjacent to a corresponding scan body, implant, abutment, healing abutment or other dental fixture and a definable feature in an interior portion of the tool is affixed relative to the dental arch area. The definable feature overlays at least part of the connecting area. The arch and arch area are scanned to produce a scanned dataset comprising multiple scan patches. Each of the scan patches has, relative to the other scan patches, a unique background provided by the depth registration tool. The unique background can be used to determine Z-axis positions for the respective scanned objects in each scan patch and/or to align the various scan patches to form a composite digital image. Data relating to the definable feature in the interior portion of the connecting-geometry tool overlaying the connecting area can be determined based on the scanned dataset. The dimensions of the connecting area can in turn be determined based on the data relating to the definable feature.

The present disclosure can provide a number of advantages depending on the particular configuration. The depth registration tool can capture accurate depth information by creating a unique background for each scan patch at each location along the arch, even though the scan bodies at each location have an identical size and shape. This ability can significantly enhance the ability of older intraoral scanners to provide an accurate digital model for restoration processes, even full arch restorations. Even on newer intraoral scanners that are more effective in forming composite images and registering objects properly, the use of a unique background can substantially enhance digital processing and simplify and shorten scanning times even for full arch scans.

These and other advantages will be apparent from this disclosure.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any computer-readable storage and/or transmission medium that participates in providing instructions to a processor for execution. Such a computer-readable medium can be tangible, non-transitory, and non-transient and take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium commonly excludes transient storage media, particularly electrical, magnetic, electromagnetic, optical, magneto-optical signals.

A “computer readable storage medium” may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may be any computer readable medium that is not a computer readable storage medium and that can communicate, propagate, or transport a program for use by or in connection with an instruction execution system, apparatus, or device. A computer readable signal medium may convey a propagated data signal with computer readable program code embodied therein, for example, in baseband or as part of a carrier wave. Such a propagated signal may take any of a variety of forms, including, but not limited to, electro-magnetic, optical, or any suitable combination thereof. Program code embodied on a computer readable signal medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section(s) 112(f) and/or 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “module” as used herein refers to any known or later developed hardware, software, firmware, artificial intelligence, fuzzy logic, or combination of hardware and software that is capable of performing the functionality associated with that element.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

The preceding is a simplified summary of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

The foregoing and other advantages of the present disclosure will become apparent upon reading the following detailed description and upon reference to the drawings.

FIG. 1 is an isometric view of a kit according to embodiments of the present disclosure.

FIG. 2 is a plan view of the kit of FIG. 1.

FIG. 3 is a plan view of a depth registration tool according to an embodiment of the present disclosure.

FIG. 4 is an isometric view of an injection molded depth registration tool according to an embodiment of the present disclosure.

FIG. 5 is a plan view of a depth registration tool and bumpers according to an embodiment of the present disclosure.

FIG. 6 is a plan view of a depth registration tool deployed beneath scan bodies according to an embodiment of the present disclosure.

FIG. 7 is a plan view of a composite scanned image according to an embodiment of the present disclosure.

FIG. 8 is a plan view of a deployed depth registration tool according to an embodiment of the present disclosure.

FIG. 9 is a plan view of a depth registration tool according to an embodiment of the present disclosure.

FIG. 10 is a plan view of a deployed depth registration tool according to an embodiment of the present disclosure.

FIG. 11 is a plan view of a deployed depth registration tool according to an embodiment of the present disclosure.

FIG. 12 is a block diagram of a computer according to an embodiment of the present disclosure.

FIG. 13 is a flow chart of an algorithm according to an embodiment of the present disclosure.

FIG. 14 is a plan view of a jaw according to an embodiment of the present disclosure.

FIG. 15 depicts a jaw engaged with multiple scan bodies according to an embodiment of the present disclosure.

FIG. 16 depicts a jaw engaged with multiple scan bodies according to an embodiment of the present disclosure.

FIG. 17 is a plan view of a depth registration tool according to an embodiment of the present disclosure.

FIG. 18 depicts a jaw engaged with multiple scan bodies and a depth registration tool according to an embodiment of the present disclosure.

FIG. 19 depicts a jaw engaged with multiple scan bodies and a depth registration tool according to an embodiment of the present disclosure.

FIG. 20 is an isometric view of a scan body according to an embodiment of the present disclosure.

FIG. 21 is an isometric view of a scan body according to an embodiment of the present disclosure.

FIG. 22 depicts a series of relationships between the scan bodies of FIGS. 20-21.

FIG. 23 depicts a series of relationships between the scan bodies of FIGS. 20-21.

FIG. 24 depicts a relationship between the scan bodies of FIGS. 20-21 and the tool of FIG. 17.

FIG. 25 depicts a relationship between the scan bodies of FIGS. 20-21 and the tool of FIG. 17.

FIG. 26 depicts a jaw engaged with multiple scan bodies according to an embodiment of the present disclosure.

FIG. 27 depicts a jaw in which rearmost implants are engaged with scan bodies according to an embodiment of the present disclosure.

FIG. 28 depicts a jaw in which a rearmost set of implants is engaged with scan bodies and the tool according to an embodiment of the present disclosure.

FIG. 29 depicts a jaw in which an intermediate set of implants is engaged with scan bodies and the tool according to an embodiment of the present disclosure.

FIG. 30 depicts a jaw in which a foremost set of implants is engaged with scan bodies and the tool according to an embodiment of the present disclosure.

### DETAILED DESCRIPTION

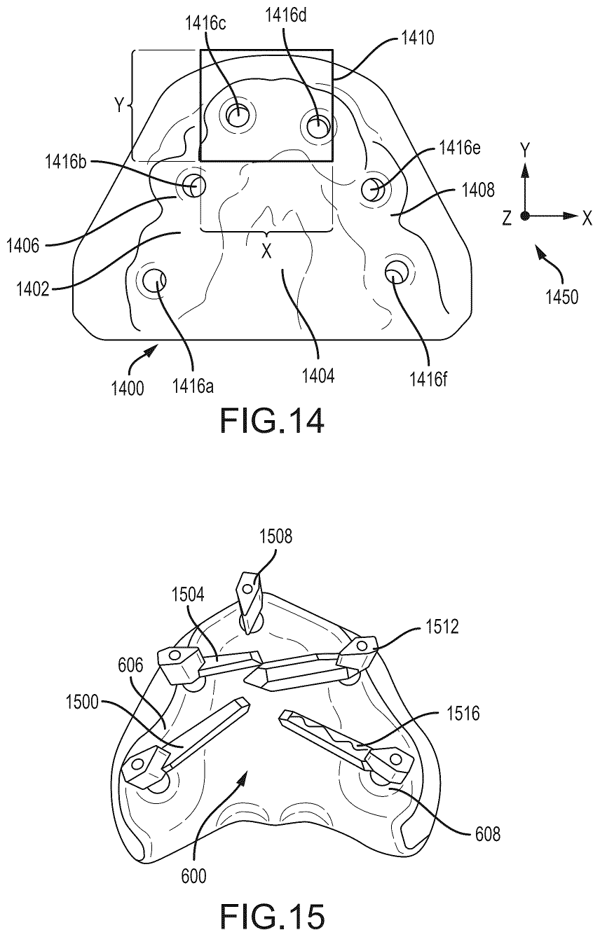

FIG. 14 is a top view of a full-arch area intra-oral scan of the arch area 1400 relative to a 3-D set of orthogonal axes 1450 comprising X, Y, and Z-axes. The arch area 1400 includes the arch 1402 and edentulous areas requiring restoration. The connecting area 1404 is disposed between the segments 1406 and 1408, which form the arch 1402. As is known, a restorative process may involve the creation of a model of the arch area 1400, which may then be used for fabrication of restorative devices such as a dental bridge matching the features of the arch area 1400. The exemplary dental bridge would be supported by restorative components, such as implants and abutments that may be inserted in the edentulous areas of the arch 1402. Of course, restorative processes may address smaller segments of the arch such as partial segments with more high edentulous areas. Since the dimensions of the arch area 1400 are necessary to produce a 3-D virtual model for the entire arch area 1400, the scanned dataset includes images of the connecting area 1404. While not shown, the arch 1402 can include teeth that provide additional distinctive landmark features in processing the scanned dataset of the arch.

To avoid loss of image information associated with features positioned within the field of view but below the depth of view of the intra-oral scanner and minimize site-to-site errors cross-arch error and/or full arch distortion, the inter-arch or connecting area 1404 may be temporarily covered with a depth registration tool during intra-oral scanning to provide an accurate interpretation of the full-arch scan. The depth registration tool extends over and bridges the gap between the open segments 1406 and 1408 of the arch 1402 and contains three-dimensional objects that are raised to a level near the scan bodies to enable more accurate full arch intra-oral scans by capturing images not only of the scan bodies but also of the three-dimensional objects, thereby enabling more accurate stitching together of images when compared to the connecting-geometry tool of U.S. Pat. No. 11,607,295. Unlike the connecting-geometry tool, the depth registration tool can not only provide one or more definable distinct features in the inter-arch connecting area that register in the scanned dataset to produce, relative to the X and Y axes, a more accurate scanned dataset of the inter-arch area 1402 and the connecting area 1404 and optionally arch and connecting area dimensions but also provide, for each scan patch at different locations along the arch, a unique background containing not only scan bodies but also three dimensional features on the tool within the field of view and depth of view of the intra-oral scanner (e.g., capturing depth (Z-axis) information in the connecting area) to be used for stitching together the various scan patches to form a composite image with lower levels of distortion. Stated differently, the depth registration tool can not only provide the accurate dimensions of the inter-arch area or connecting area and separation between the open segments 1406 and 1408 and dimensional data for error assessment based on data in the scanned dataset relating to the one or more definable features of the depth registration tool but also can provide accurate depth (or Z axis) information and a more accurate composite image. The resulting dataset can be used to create an accurate 3D virtual model of the arch and connecting area for implant installation and/or restoration processes.

As will be appreciated, a scan patch is a function of the intra-oral scanner's field of view 1410 (FIG. 14) having a certain X and Y dimension and depth of view (normal to the page of FIG. 14) having a certain Z dimension. As will be appreciated, the size and shape of the field of view 1410 and depth of the depth of view depends on the type of intra-oral scanner employed. While FIG. 14 shows an exemplary rectangular field of view 1410 in plan view (not drawn to scale), it is to be understood that the field of view 1410 can have any geometrical shape, and it is to be further appreciated that there is not just one but multiple spatially distributed scan patches 1410 positioned over the intra-orally scanned area. A scan is generally a plurality of sequentially scanned images or scan patches 1410, which are typically overlapping. The goal is to convert each image or scan patch into digital point cloud, with each point having a location relative to the localized X, Y, and Z coordinate system 1450 associated with the corresponding scan patch. The various digital point clouds and associated localized X, Y, and Z coordinate systems 1450 are stitched together to form a composite image.

As will be appreciated, scan frames or patches are stitched together using specialized software that aligns overlapping images, merges similar or common features, and blends them into a single, larger composite image. The process typically involves manually intra-oral scanning of the patient's arch in overlapping sections, importing the overlapping images into the software, and allowing the software to automatically register, align, and merge the overlapping images into one continuous composite image.

The accuracy of the composite image of the arch and inter-arch area can be important to a successful dental restoration. To register objects and provide a composite image, the various digital point clouds desirably have overlapping points referencing a common identifiable feature. If the overlapping feature is not unique relative to overlapping features of other digital point clouds in other scan patches, however, the accuracy of the stitched together composite image can be compromised leading to distortion, which can be particularly significant in full-arch scans.

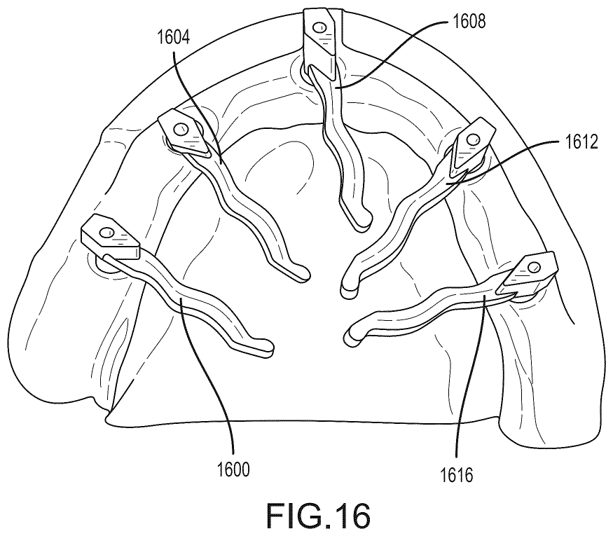

To provide a more accurate composite image, one solution shown in FIGS. 15-16, employs elongated scan bodies 1500-1516 and 1600-1616 that have sufficient length across the inter-arch area to overlap each other. The scan bodies 1500-1516 and 1600-1616 comprise spatially distributed elongated arms extending inwardly into the arch 1402. The arms may have common or different shapes and features depending on the application. In particular, the scan bodies 1500-1516 have elongated arms of differing lengths and shapes. As can be seen, the scan bodies 1512 and 1516 have different shapes than scan bodies 1500 and 1504. Scan body 1508 does not have an elongated arm. In contrast, scan bodies 1600-1616 have identical lengths and shapes. While this approach may assist in stitching the various images into a composite image, it can in some cases fail to provide accurate depth information and fail to alleviate composite image distortion for certain types of intra-oral scanners, particularly older intra-oral scanners having more limited depths of view.

While not wishing to be bound by any theory, it is believed that the inaccuracy of the approaches using elongated scan bodies alone is due at least in part to the failure to capture accurate depth information. The depth information can be captured accurately by creating a unique 3D background for each scan patch at each location along the arch. While the scan bodies at each location have an identical size and shape, the raised surfaces of the objects on the tool can provide a unique 3D background for each scan patch and provide common features in overlapping scan patches that can be used for stitching. Even on newer intraoral scanners that are more effective in forming composite images and registering objects properly, the use of a unique background can substantially enhance digital processing and simplify and shorten scanning times even for full arch scans.

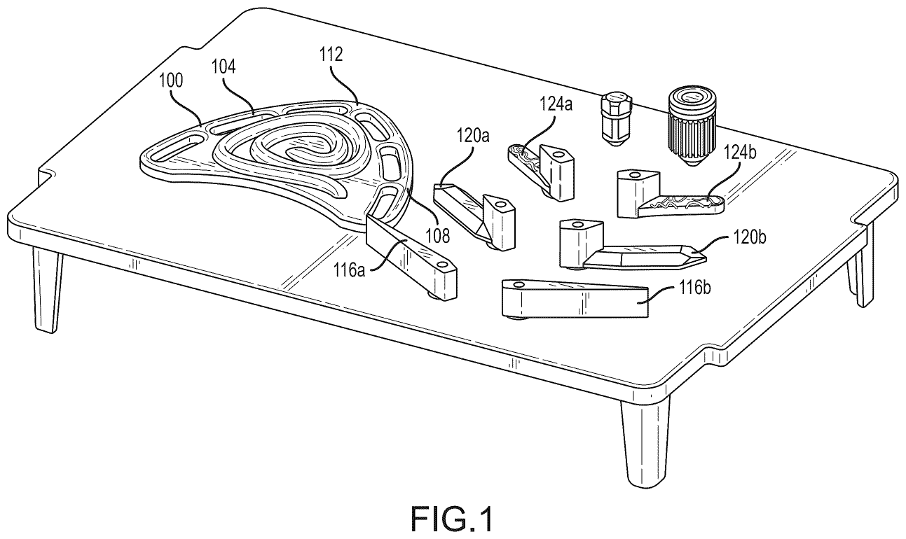

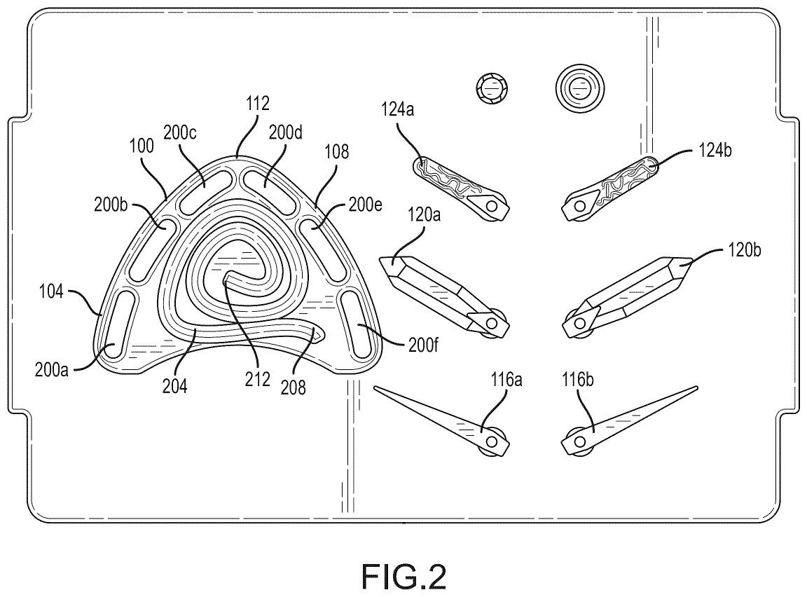

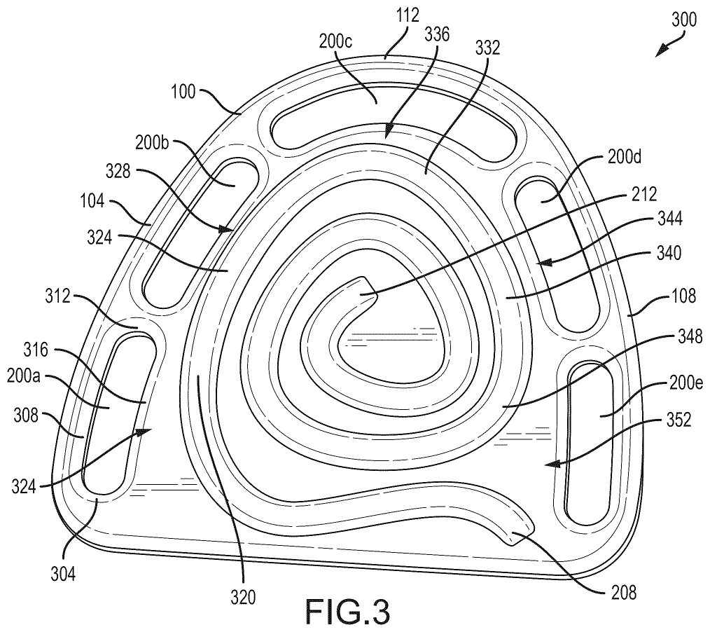

An example of the depth registration tool is shown in FIGS. 1-4. The tool 100 comprises arcuate outer edges 104 and 108 meeting at a pointed or rounded crest 112. Plural pairs of scan bodies 116a,b, 120a,b, and 124a,b are engaged with implants or abutments (not shown) in the arch for a full dental restoration. The outer edges 104 and 108 comprise plural apertures 200a-e to receive an implant, scan body, abutment, healing abutment, or other dental fixture to maintain the depth registration tool in a stationary or fixed position during scanning. Alternatively, an adhesive, such as dental acrylic applied to the segments 1406 and 1408 and the tool 100 or a mechanical device, such as a pin or pins, attaching segments 1406 and 1408 to the tool 100 can anchor the tool 100 in position prior to scanning. While six apertures are shown in FIG. 2 and five in FIG. 3, it is to be understood that any number of apertures may be employed depending on the size and number of scan bodies to be employed. Each aperture is defined by opposing pairs of sidewalls 304 and 312 and 308 and 316.

The central portion of the depth registration tool overlays and blocks scanning (or light reflection from) typically of at least most and more typically of at least about 75% of the underlying inter-arch or connecting area and comprises a raised arcuate ridge 204 following an arbitrary, serpentine, undulating, or winding pathway through the central portion. As can be seen from FIG. 2, the ridge 204 has a first end 208 near the aperture 200f and a second end 212 in the central portion of the tool and is raised or elevated relative to and vertically offset along the Z-axis relative to the surrounding portions of the tool 100.

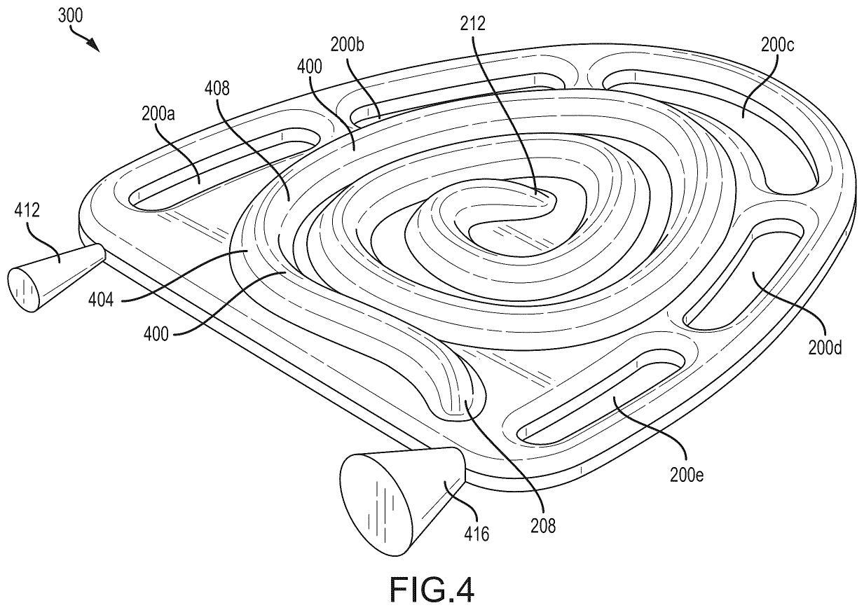

The tortuous pathway of the ridge 204 causes the ridge 204 to be located at different positions relative to the nearby plural apertures 200a-f, thereby creating a unique background for each scan body received in the respective aperture. This is further illustrated by the tool 300 shown in FIGS. 3-4. A first portion 320 of the ridge 204 nearest the first aperture 200a has along its length a first set of spatial or dimensional relationships 324 (e.g., intervening distances, etc.) relative to the first aperture's sidewalls, first degree of curvature and/or a dimension of the ridge itself (e.g., width/height of ridge crest or flank, etc.); a second portion 324 of the ridge 204 nearest the second aperture 200b has along its length a second set of spatial or dimensional relationships 328 relative to the second aperture's sidewalls, second degree of curvature and/or a dimension of the ridge itself; a third portion 332 of the ridge 204 nearest the third aperture 200c has along its length a third set of spatial or dimensional relationships 336 relative to the third aperture's sidewalls, third degree of curvature and/or a dimension of the ridge itself; a fourth portion 340 of the ridge 204 nearest the fourth aperture 200d has along its length a fourth set of spatial or dimensional relationships 344 relative to the fourth aperture's sidewalls, fourth degree of curvature and/or a dimension of the ridge itself; and a fifth portion 348 of the ridge 204 nearest the fifth aperture 200e along its length has a fifth set of spatial or dimensional relationships 352 relative to the fifth aperture's sidewalls, fifth degree of curvature and/or a dimension of the ridge itself. These relationships and degrees of curvature are within a respective scan patch area containing each aperture and therefore are selected based on scanner resolution or field of view. In addition, the first end 208 of the ridge is within the localized scan patch area including the fifth aperture but outside the scan patch areas including the other apertures. As can be seen from the foregoing, each aperture's scan patch will have a unique set of spatial relationships and/or radius of curvature and/or ridge dimension(s), thereby providing a unique background for the corresponding scan body. As can be further seen from FIGS. 3-4, the central area of the tool 300 has a plurality of definable features to provide the dimensions of the inter-arch area, including the second end 212 and portion of the ridge 204 located interiorly of the first, second, third, fourth and fifth ridge portions.

In some embodiments, a virtual counterpart of the tool, in a stored library of virtual counterparts of the tool and scan bodies, can be used to determine known dimensions and distances of the various sets of spatial or dimensional relationships for use in determining dimensional data for error assessment and correction relative to the X, Y, and Z axes. The known dimensions and distances may be compared with the dimensions obtained from the scan dataset containing each portion of the ridge and an error (or distortion) correction factor may be determined based on the difference of the scanned dimensions and the known actual dimensions. The error (or distortion) is used to determine the skew in the scan dataset relative to the X, Y and Z-axes The spatial or dimensional relationships for a given scan patch, once scanned, can be automatically identified by software algorithms and compared, by the software, with the appropriate set of spatial or dimensional relationships in the virtual counterpart to automatically correct the scanned dataset on a multiple frame or frame-by-frame basis to produce a corrected intraoral dataset that may be converted into a three-dimensional model of the scanned image (including the scanned image of the tool and scan bodies). This technique is analogous to scanning both the patient and tool simultaneously and then error correcting the scan dataset based on the interpretation of the dimensions determined from the scan of the tool. This embodiment may not be beneficial when the tool is highly elastic and deforms when engaging the various scan bodies. The virtual counterpart of the tool, being undeformed, could not be shape matched to the imaged tool.

In an embodiment, because the tool and possibly scan bodies block the underlying geometry in the arch or connecting area, including features such as teeth or other areas of interest of the arch, an initial scan may be taken of the arch area in the absence of the tool and/or scan bodies to produce the image of FIG. 14. A second scan may then be taken of the arch area with the tool and scan bodies in place. The initial scan without the tool and scan bodies may then be error corrected using the scan bodies and/or tool from the second scan as reference objects to provide a three-dimensional model comprising virtual representations of the tool and/or scan bodies and the underlying arch. This can be done by shape matching the virtual counterpart of the scan bodies and/or tool to each of the corresponding scanned counterparts in the scan dataset. As will appreciated, shape matching compares and recognizes shapes based on their geometric properties, such as size, angles, and curvature. It typically involves measuring the similarity or distance between shapes, often by applying transformations like rotation, scaling, and translation to align them for comparison. Shape matching can be done on a frame-by-frame or composite image (after stitching) basis by matching a scanned portion of the scan body or tool against the corresponding portion of its virtual counterpart and appropriately modifying the scan dataset. Apart from error correction, shape matching of the scan body and/or tool can locate, relative to the 3D axis system, not only scanned features but also hidden features, such as the orientation and seating surface location for a given implant. In particular, shape matching the tool's elevated features against the scanned image of the tool can enable location relative to the Z axis of the potions of the arch itself. The modified scan dataset can be implemented as a 3D virtual model. Once the scan dataset is error corrected and adjusted relative to the 3D axis system, the scan dataset of the connecting area shown in FIG. 14 can be incorporated into the 3D virtual model by shape-matching based on the corrected scan dataset to provide a composite 3D virtual model.

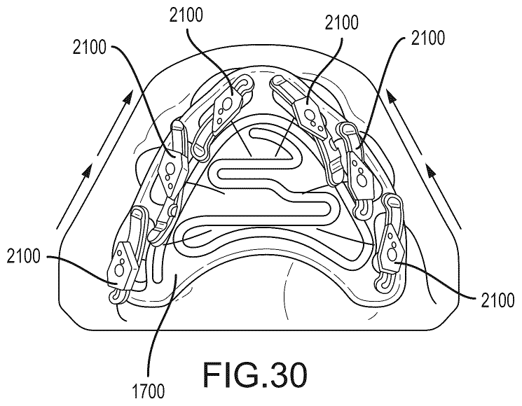

Using the composite 3D virtual model, the virtual representation of the tool and/or scan bodies can be removed to reveal accurate virtual representations of the connecting area 1404, the segments 1406 and 1408 which form the arch 1402 as well as the implant position and seating surface locations. By way of example, the three-dimensional model could include an error corrected scanned image similar to FIG. 30 based on the modified scan dataset and, after removal of the tool and scan bodies, output an image similar to an error corrected version of FIG. 14, showing the positions of the various implants and other dental features.

With reference to FIG. 4, the cross-sectional shape of the ridge is illustrated. Specifically, the ridge 204 comprises a crest 400 flanked by first and second flanking ridge portions 404 and 408. The first and second flanking ridge portions 404 and 408 are substantially planar surfaces that extend downwardly away from either side of the raised crest to the lower valley floor on either side of the ridge. The angle between the flanking ridge portions can be any angle depending on the application.

The tool can be rigid, semi rigid, or pliable (elastic) depending on the application. Typically, the tool is formed from a pliable or deformable polymeric material, such as silicone, and is formed by injection molding techniques. FIG. 4 further shows the sprues 412 and 416 from injection molding of the tool 300. Other types of plastic molding techniques may be employed, such as rotational molding, blow molding, reaction injection molding, compression molding, structural foam molding, extrusion molding, thermoforming, gas assist molding and the like. The tool can also be rigid or semi rigid to avoid tool deformation due to tongue movement during scanning. In such applications, the tool can be formed from a rigid plastic or metal. Other materials, such as polymeric materials and metal composites, may be used to form the tool.

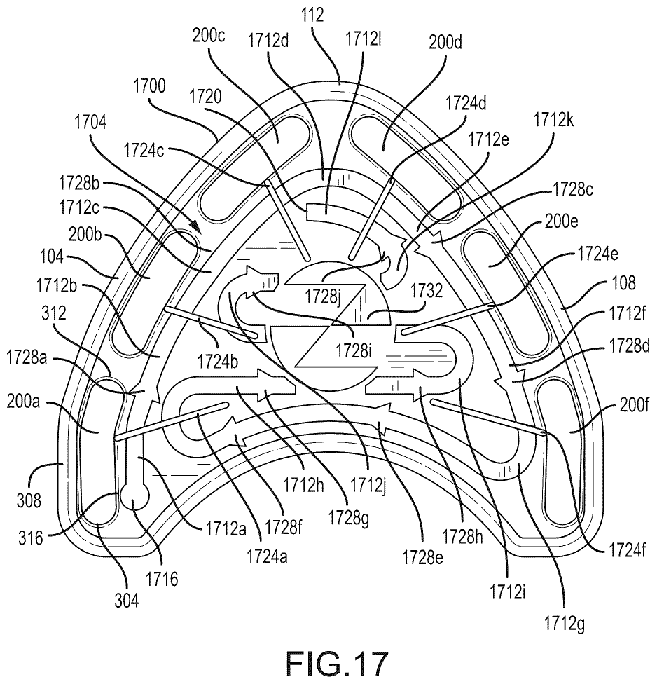

Another example of the depth registration tool 1700 is shown in FIGS. 17-20. The tool 1700 comprises arcuate outer edges 104 and 108 meeting at a pointed or rounded crest 112. The outer edges 104 and 108 comprise plural apertures 200a-e to receive an implant, scan body, abutment, healing abutment, or other dental fixture to maintain the depth registration tool in a stationary or fixed position during scanning. Alternatively, an adhesive, such as dental acrylic applied to the segments 1406 and 1408 and the tool 100 or a mechanical device, such as a pin or pins, attaching segments 1406 and 1408 to the tool 100 can anchor the tool 100 in position prior to scanning. While six apertures are shown in FIG. 17, it is to be understood that any number of apertures may be employed depending on the size and number of scan bodies to be employed. Each aperture is defined by opposing pairs of sidewalls 304 and 312 and 308 and 316.

The central area or portion 1704 of the depth registration tool 1700 comprises a discontinuous or segmented raised arcuate ridge 1708 comprising multiple raised segments 1712a-l (relative to the valley floor positioned on either side of the segments) following an arbitrary, serpentine, undulating, or winding pathway through the central portion 1704. The ridge 1708 has a first end 1716 near the aperture 200a and a second end 1720 in the central portion near the crest 112 of the tool. The ridge 1708 is interrupted or cut in multiple locations along its path by transverse cuts 1724a-f extending from a corresponding aperture 200a-e into the central portion 1704, which transverse cuts may pass completely through the tool 1700 to provide increased flexibility to receive scan bodies in the plural apertures during tool placement in the arch. Also, raised arrows 1728a-j are positioned along the length of the ridge 1708 as further identifiable feature to create a unique 3D background for each scan patch. As will be appreciated, more or fewer segments 1712a-l or arrows 1728a-j may be employed depending on the application. Finally, a raised logo 1732 is positioned in the central portion 1704 to provide a further identifiable 3D feature.

To provide increased reactance to light projected by the intra-oral scanner, the tool can comprise optically reflective materials, such as reflective or retro reflective glass or ceramic beads. The glass or ceramic beads can be of any type and typically have a size ranging from about 25 to about 400 micrometers and more typically from about 50 to about 250 micrometers in diameter. The beads are typically Type I beads, though other types of reflective beads may be used. The amount of beads included in the tool typically ranges from about 10 to about 50 vol. % and more typically from about 25 to about 45 vol. %.

While FIGS. 1-4 illustrate a specific structure and structural 3D relationships for the ridge 204, it is to be understood that an endless number of alternative tool designs are possible so long as each aperture has a unique 3D background in the localized scan patch comprising the aperture and corresponding scan body. For example, the ridge can be a channel following has along its length a fifth set of spatial relationships 344 relative to the fifth aperture's sidewalls and fifth degree of curvature. In that configuration, the raised portions of the tool relative to the channel, rather than the channel itself, would be captured by the intra-oral scanner. The first, second, third, fourth and fifth sets of spatial relationships are different from one another and the first, second, third, fourth and fifth degrees of curvature are different from one another. In addition, unlike the other apertures the fifth aperture is adjacent to the first end of the ridge, which provides a further unique feature in the scan patch of the fifth aperture.

As will be appreciated, the ridge 204 and other identifiable features can be replaced by other 3D structures, such as a number of dimples or indentations with each aperture having a different number or design of dimples or indentations positioned to appear in the corresponding localized scan patch. In another example, the ridge 204 and other raised or positive features could be replaced by a discontinuous ridge or channel following the same pathway as the ridge, or a combination thereof. Other definable features can be envisioned provided each aperture has a unique spatial relationship and/or uniquely designed definable feature within the spatial area encompassed by its respective scan patch.

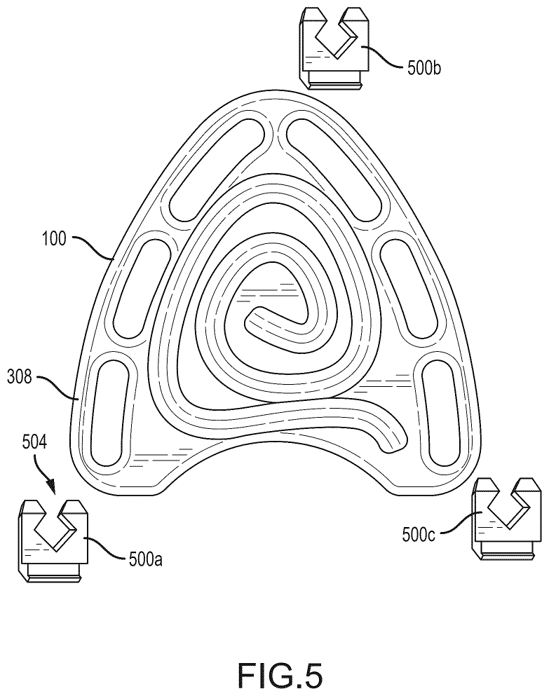

With reference to FIG. 5, bumpers 500a-c can be used to connect the tool 100 to a scan body, healing abutment, abutment or other dental fixture. The open end of the bumper is first passed though the outer wall 308 of an aperture 200 and then engaged with the dental fixture to maintain the tool in a desired position.

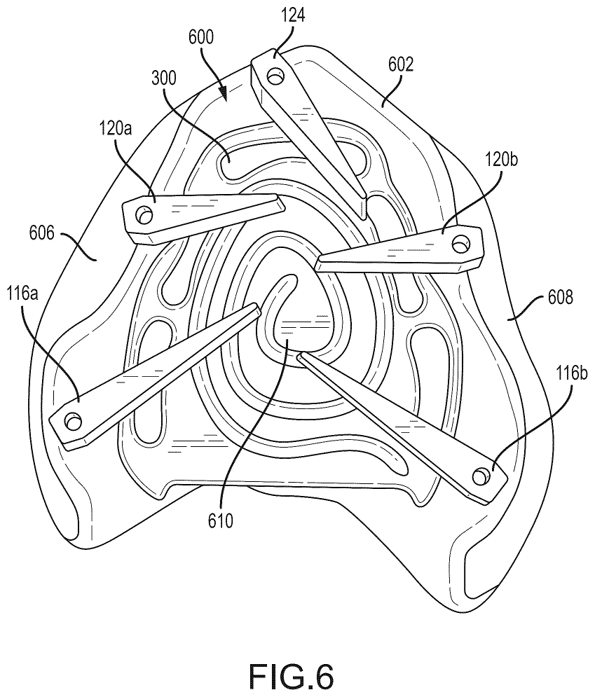

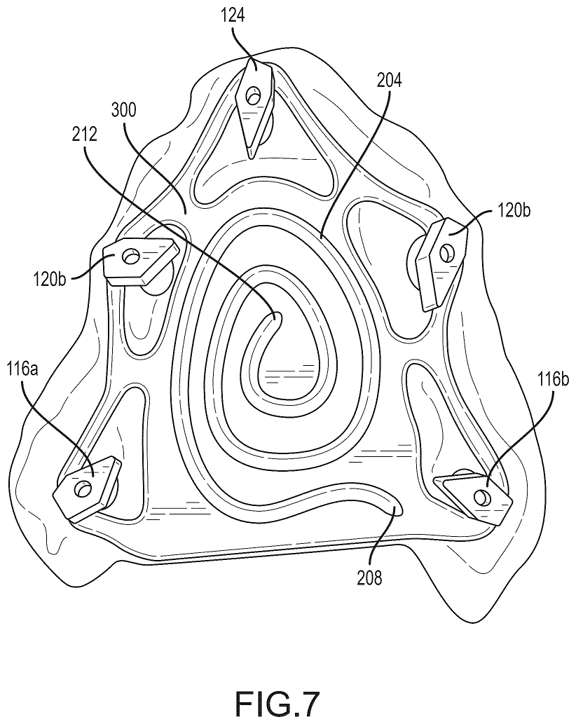

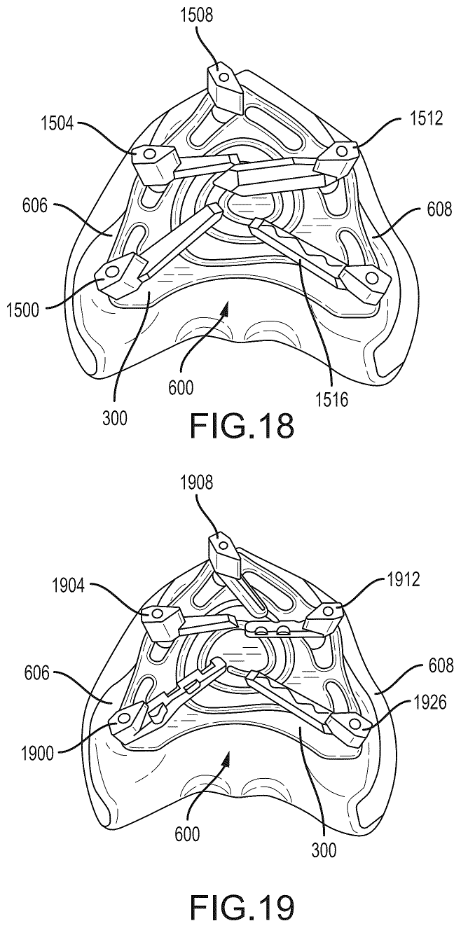

FIGS. 6 and 18-19 shows the tool 100 engaged with various types of scan bodies 1500-1516 and 1900-1926 in a physical model of an arch in preparation for scanning. The tool 300 is positioned in the arch area 600 below the scan bodies 116a,b, 120a,b and 124 (FIG. 7), 1500-1516 (FIG. 18), and 1900-1926 (FIG. 19) to avoid the intra-oral scanner tip from contacting the pliable tool, thereby deforming the tool and causing distortion in the scanned image. The long dimension of each of the scan bodies is generally oriented interiorly of the alveolar ridge towards the central portion of the tool. The arch area 600 includes the arch 602 which includes teeth (not shown) and edentulous areas (not shown) requiring restoration. The connecting area 610 is disposed between the segments 606 and 608 which form the arch 602. As is known, a restorative process may involve the creation of a model of the arch area 600 which may then be used for fabrication of restorative devices such as a dental bridge matching the features of the arch area 600. The exemplary dental bridge would be supported by restorative components, such as implants and abutments that may be inserted in the edentulous areas of the arch 602. Of course, restorative processes may address smaller segments of the arch such as partial segments with more high edentulous areas. While the apertures may be connected directly to the base of the scan body, or indirectly to the base of the scan body using the bumpers, the tool may also be positioned below but not directly or indirectly connected with the scan bodies as shown in FIG. 6. The latter configuration is possible when the scan bodies have sufficient length to maintain the tool in a stable position during scanning.

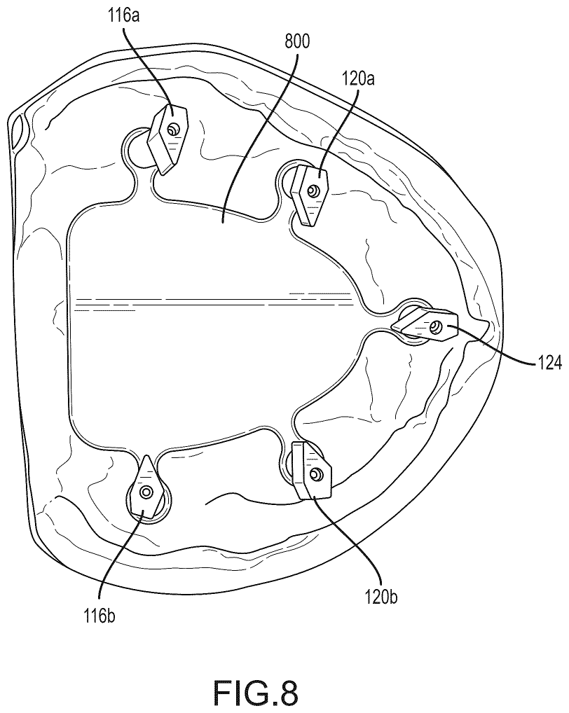

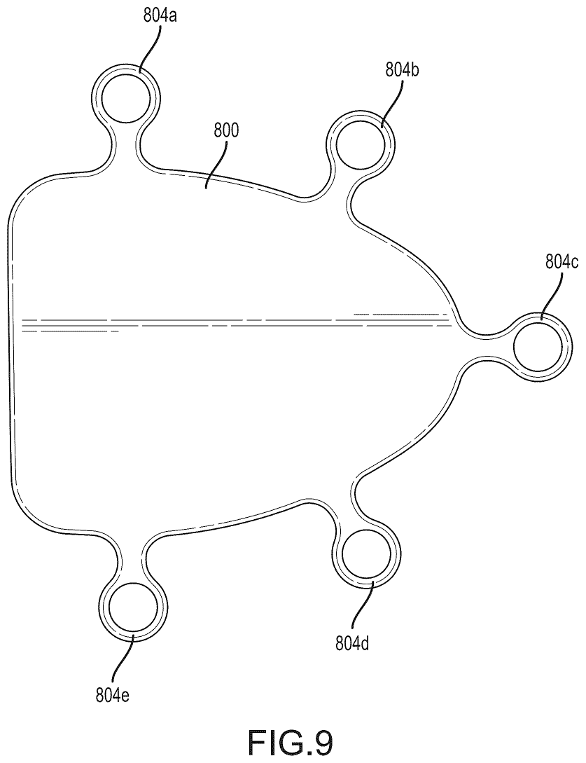

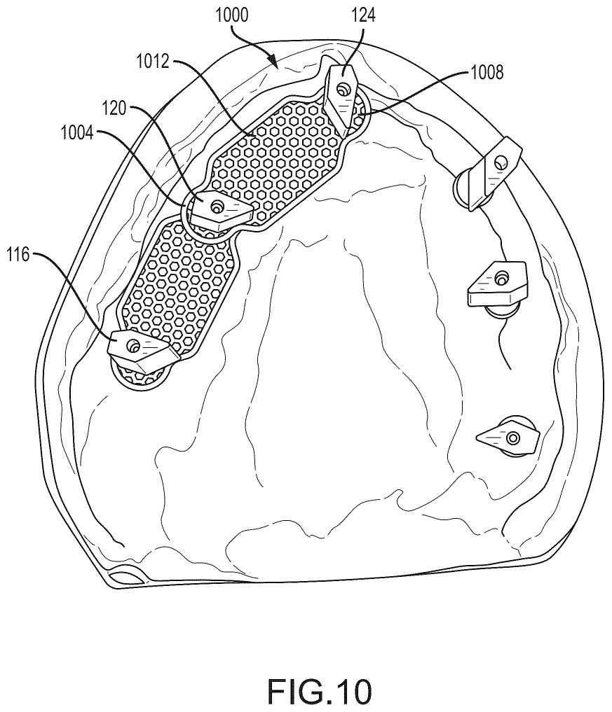

Another tool securement embodiment is shown in FIGS. 8-9. The tool 800, which is depicted without the ridge 204 for the sake of simplicity, has plural attachment arms 804a-e, each of which comprises a circular aperture and is engaged with the implant or abutment before implant or abutment engagement with the scan body. The resulting tool is attached beneath the scan bodies as shown in FIGS. 8 and 10.

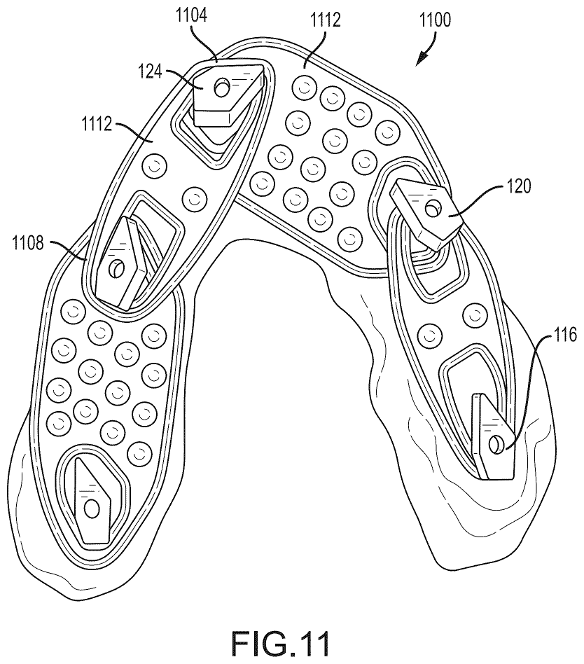

Another embodiment of the tool is shown in FIG. 10 in which plural depth registration tools 1000 and 1100 are depicted. Opposing ends 1004 and 1008 or 1104 and 1108 include attachment arms comprising a circular aperture to engage the opposing implants or abutments before implant or abutment engagement with the scan body. These tools 1000 and 1100 are particularly useful for scan patches taken along only sections of the arch and not for full arch scans requiring imaging of the inter-arch area. Each of the tools 1000 and 1100 has a differently configured upper surface 1012 and 1112 to provide a unique background to the scan patch. While the surface is shown to have holes or pits 1016 (FIG. 10) or dimples 1116 (FIG. 11), other patterns may be employed so long as each of the tools has a unique pattern compared to the other tools along the arch to provide the desired unique background. As shown in FIG. 11, the long dimension of the scan bodies is in substantial alignment with the crestline of the alveolar ridge to improve scanning accuracy.

In other embodiments, the depth registration tool is incorporated into the scan bodies. This can be done by providing a substantially planar, uniquely patterned surface containing 3D features at or near the bottom of the scan body. Stated differently, the patterned surface projects outward from a position below the upper surface of the elongated scan body 116 and on one or both sides of the elongated scan body 116, 120 or 124. Such scan bodies could be calibrated and 3D printed by the clinician.

In other embodiments, the depth registration tool of FIGS. 10-11 can be used with or as an alternative to or integrated with the connecting-geometry tool of U.S. Pat. No. 11,607,295, which is incorporated herein by this reference, or the depth registration tool of FIG. 3 or 17. By way of illustration, the connecting geometry tool could be used to image the inter-arch area while the tools 1000 or 1100 are used to image selected portions of the arch.

As noted, the depth registration tool has surface features non-uniformly distributed over its surface area to enable the field of view of each scan patch to have a unique captured 3D background image, thereby enabling objects in the various scan patches to be accurately registered according to a uniform Z, Y, and Z coordinate system and stitched together to form the composite image or digital model of the full arch of a patient. As is known, the restorative process uses the model of the arch area for fabrication of restorative devices such as a dental bridge matching the features of the arch area. The exemplary dental bridge would be supported by restorative components, such as implants and abutments that may be inserted in the edentulous areas of the arch. Of course, restorative processes may address smaller segments of the arch such as partial segments with more high edentulous areas.

FIGS. 20-25 depict scan bodies according to an embodiment of the present disclosure. The scan body 2000 of FIG. 20 comprises an upper scan body 2004, a lower convex elongated arm 2008 extending anteriorly and posteriorly of the upper scan body 2000, and a base 2012 to provide different gingival levels and engage an implant or abutment. FIG. 21 depicts a scan body 2100, similar to that of FIG. 20, having the same upper scan body 2000 and base 2012 and a lower concave elongated arm 2104. The upper scan body 2004 comprises a bore 2016 to receive a screw (not shown) that attaches to a threaded bore in an underlying implant or abutment and information markers 2020 to provide additional information related to one or more of a library identifier of a virtual counterpart used in shape matching to determine the seating surface position and orientation of the implant relative to a selected point reference, a dimension of the scan body, an orientation of the scan body relative to an underlying nonrotational feature, and other information.

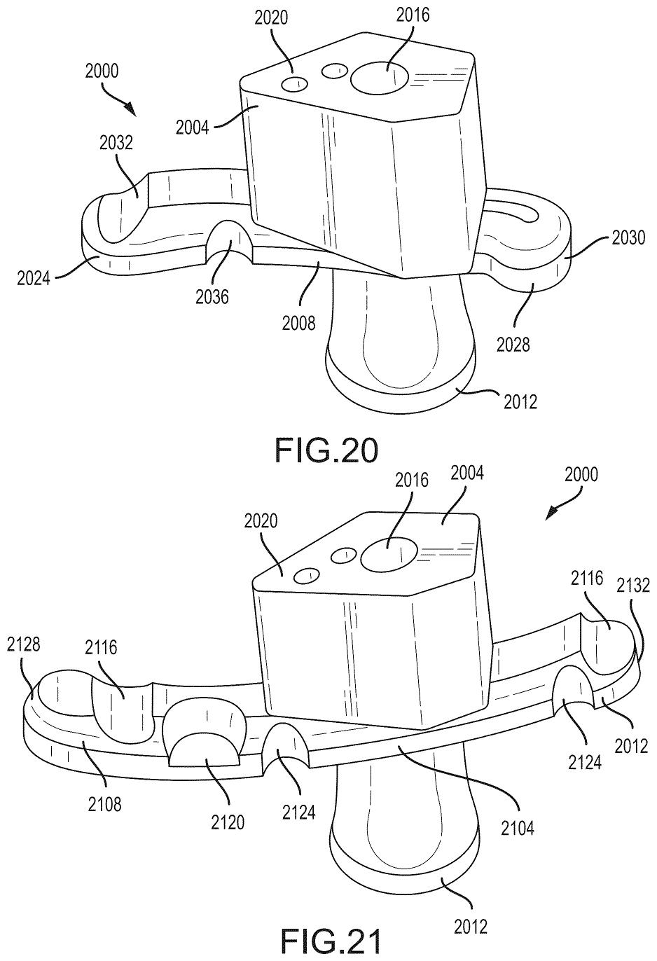

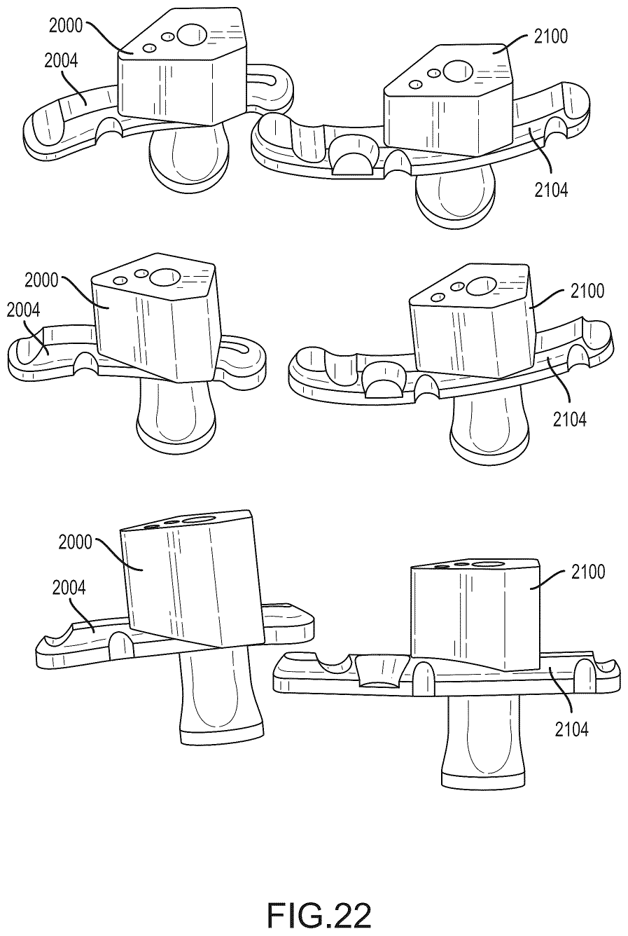

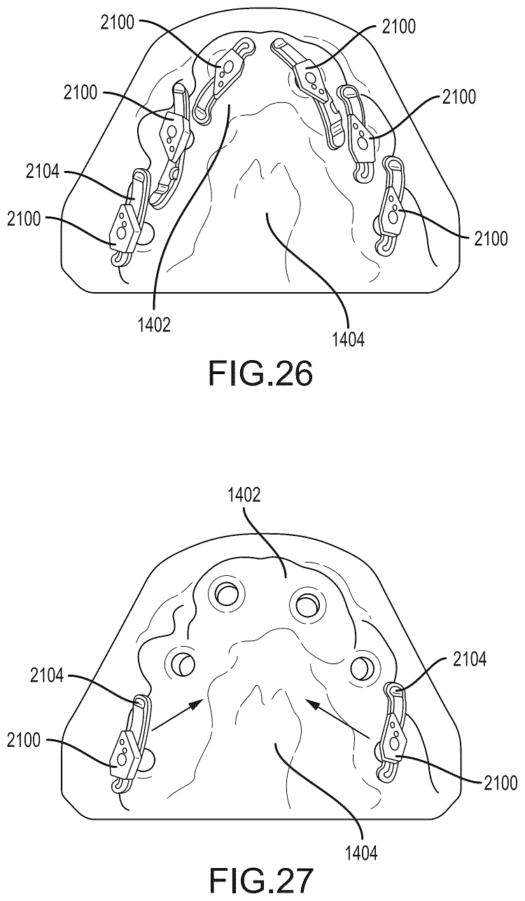

The lengths of the arms 2008 and 2104 are less than the aperture length of the apertures 200 to enable the tool to be attached to the scan body after the scan body is attached to the underlying implant or abutment. The length of the arm 2008 is shorter than that of arm 2104 to accommodate narrow and wide jaws of patients by positioning scan bodies having the appropriate arm lengths along the alveolar ridge as described below with reference to FIGS. 22-25. The arms 2008 and 2104 are typically oriented along, aligned with, or substantially parallel to the alveolar ridge as shown in FIGS. 26-27 rather than interiorly towards the connecting area 1404 as shown in FIGS. 15-16 and 18-19.

Each of the arms 2008 and 2104 comprise plural 3D irregularities that can provide additional distinct 3D features for shape matching against a virtual counterpart of the scan body to locate the scan body relative to the coordinate system, for stitching adjacent scan patches together, and correcting errors relative to the X and Y axes. Specifically, the downwardly inclining or convex arm 2008 comprises elongated valley 2032, notch 2036, and protruding edge 2028 while the upwardly including or concave arm 2104 comprises elongated valleys 2116, blind hole or pit 2120 and notches 2124, each of which has a known spatial position and dimension (e.g., depth or length or wide) relative to the anterior or posterior end 2024 or 2030 (FIG. 20) or 2128 or 2132 (FIG. 21) of the respective arm. As explained above, since the dimensions and spatial relationships of the distinctive 3D features are known based on the stored virtual counterpart of the scan body, error correction may be performed in real-time by comparing the known dimensions with those dimensions obtained when the features are determined from the scanned dataset. The resulting scanned dataset may be error corrected in real-time. The 3D features may also be shape matched against the same features in the virtual scan body counterpart to locate scanned images relative to the 3D axis system. While the scan bodies 2000 and 2100 are shown in use with the tool 1700, it is to be appreciated that they be used in the absence of the tool as shown in FIG. 26.

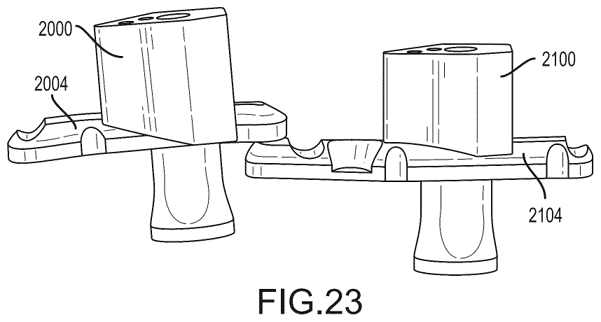

The relative positioning of the scan bodies 2000 and 2100 will be discussed with reference to FIGS. 22-25. As shown in FIG. 22, the elongated arms of the scan bodies should be located in a row so long as the arms do not prevent proper attachment (e.g., screwing) into the implant or abutment and such that the arms are not overlapping one another. In contrast, FIG. 23 depicts an incorrect position in which the posterior end of an arm of a first scan body contacts an anterior end of an arm of an adjacent second scan body. This position can prevent a correct fit on the underlying abutment shoulder. As will be appreciated, the concave and convex surfaces of the scan bodies 2100 and 2000, respectively, can enable the scan bodies to be positioned in close proximity to each other (e.g., when implants are associated with adjacent tooth positions) such that the ends of the adjacent arms overlap without unwanted contact.

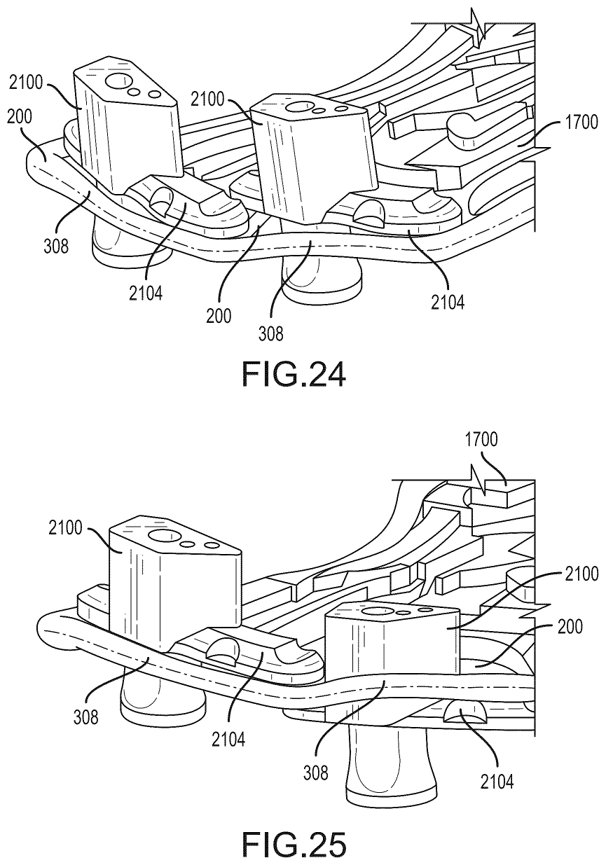

FIGS. 24-25 depict the proper and improper positions of a scan body relative to the tool 1700. FIG. 24 depicts the proper position of a scan body with the anterior and posterior portions of the arms in contact with and positioned above the upper surfaces of the opposing pairs of sidewalls 304 and 312 and 308 and 316 of the corresponding aperture. As can be seen from FIG. 24, the top or upper surfaces 2400 of the raised features on the tool 1700 (which are substantially coplanar with one another) are spatially proximal to the upper and lower surfaces 2404 and 2408 of the arms to enable the upper surfaces 2400 of the raised features of the tool 1700 to be captured by an intra-oral scanner (having a limited depth of view) substantially simultaneously as capturing the upper scan body and upper surface 2404 of the arm. In this manner, such intra-oral scanners can capture not only the upper scan body and arms but also at least the upper surfaces of the raised features such that at last a spatially portion of the upper surfaces 2400 of the raised features of the tool 1700 are captured in a common scan patch or frame as the selected upper scan body and spatially adjacent upper surface 2404 of the arm. FIG. 25 depicts the improper position of the scan body with one or both of the anterior and posterior portions of the arms positioned below the lower surfaces of the opposing pairs of sidewalls 304 and 312 and 308 and 316 of the corresponding aperture. In this position, the tool 1700 would block capture of images of the upper surface of the arm positioned beneath the lower surface of the tool.

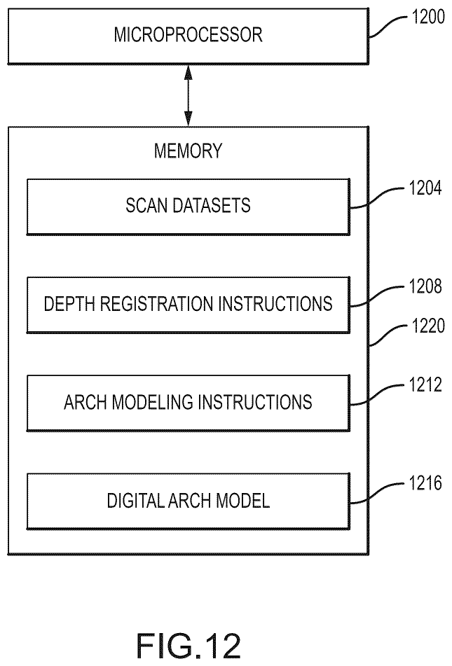

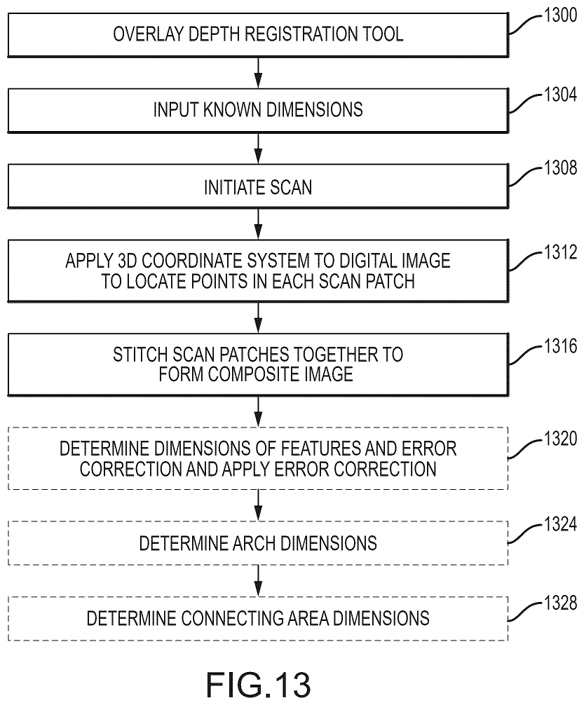

The operation of the scan process will now be described with reference to FIGS. 12-13. The processing of the scan data may be done by a processor 1200 processing the scan datasets 1204 by executing depth registration instructions 1208 and arch modeling instructions 1212 to output a digital arch model 1216. As shown, the scan datasets 1204, depth registration instructions 1208, arch modeling instructions 1212, and digital arch model 1216 are stored in computer readable memory 1220. The controller of the intra-oral scanner may alternatively perform one or more of the operations in the depth registration instructions and/or arch modeling instructions. Although an example algorithm corresponding to the depth registration instructions 1208 and arch modeling instructions 1212 is described with reference to the flowchart illustrated in FIG. 13, persons of ordinary skill in the art will readily appreciate that many other methods of implementing the example machine readable instructions may alternatively be used. For example, the order of execution of the blocks may be changed, and/or some of the blocks described may be changed, eliminated, or combined.

As discussed below, the model 1216 of the dental arch area is created using the scan datasets 1204 obtained from three-dimensional intra-oral scanning. The output of such a digital model is shown in FIG. 7, which shows the depth registration tool 300 positioned in the connecting area attached to the various scan bodies 116a,b, 120a,b and 124. The definable features in the connecting area include the interior portion of the ridge 204 and/or second end 212 of the ridge 204. The model 1216 may be used to fabricate models of the arch area for preparation of restoration devices.

Referring to FIG. 13, the digital dead space represented by the connecting area is covered with the depth registration tool to bridge the gap between open segments of the arch (step 1300). The depth registration tool is temporarily affixed to the area of interest such as the arch and extends over the connecting area. The depth registration tool ideally contains the ridge 204 and optionally other distinct features that register in the scan dataset produced when scanning the connecting area. The resulting scanned dataset therefore includes more accurate scans of both the arch and the connecting area with the depth registration tool because of the inclusion of scannable or definable features overlaying the connecting area coupled with a unique background for each scan patch.

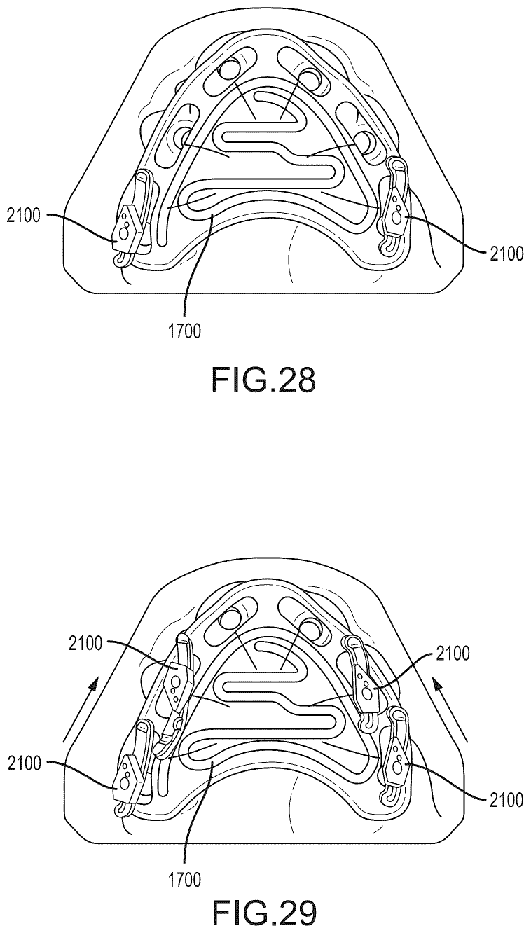

Referring to FIGS. 14 and 26-30, the positioning and attachment of the depth registration tool in the connecting area or digital dead space between the open segments of the arch is further depicted using the scan bodies of FIGS. 20-21. FIG. 14 depicts the open segments 1406 and 1408 and connecting area 1404. The alveolar ridge comprises six spaced implants 1416a-f that will be used to attach a screw-on bridge for engagement with a denture. Referring to FIG. 27, scan bodies 2100 are attached to the rear most implants. As shown in FIG. 26, the remaining scan bodies 2100 can be attached to the remaining implants prior to tool 1700 placement. In this case, the apertures and transverse cuts work together along with the deformability of the pliable tool to enable each aperture to be placed over and then under the arms 2104. Alternatively, the rearmost apertures in the tool 1700 can be placed over and under the arms of the rear most scan bodies 2100 (FIG. 28) to temporarily hold the tool in position followed by placement of the remaining scan bodies 2100 from back to front (as shown by the arrows) through the remaining apertures into engagement with the respective implant as shown in FIGS. 29-30 until the tool is securely secured into scanning position. As noted, the arts 2104 of the scan bodies 2100 are in substantial alignment with the alveolar ridge as shown in FIGS. 26 and 30.

In step 1304, the user inputs known dimensions of the one or more definable features of the depth registration tool which may be registered by the scanner. These dimensions may also be previously stored in a library such as in a virtual counterpart for the specific connecting-geometry tool for convenient access by the scanner controller.

In step 1308, the scan is initiated. One example of intra-oral scanning involves a handheld three-dimensional intra-oral scanner that may be used to scan the arch area to produce the dataset. An exemplary three-dimensional intra-oral scanner may include two stereo cameras that capture image data from an area of interest (such as an individual tooth or the entire arch area) in a series of frames. The intra-oral scanner emits polarized or unpolarized light, redirects and focuses by a lens the reflected light (e.g., specular, surface scattered, and/or subsurface (volume) scattered light) onto a sensor, and captures, by the sensor, the light reflected from the scanned object to create an image of the scanned object. Each captured image corresponds to a frame (or a point cloud). A single intra-oral scan of a portion of a patient's arch area can generate hundreds or even thousands of frames. The various images are then stitched together to create a 3D image of the scanned object(s) in the arch area. Exemplary intra-oral scanner systems may include but not be limited to the 3M Lava C.O.S., the Cadent iTero digital impression system, the AORALSCAN intra-oral scanner, CARESTREAM intra-oral scanner, CANDOR intra-oral scanner, MEDIT 1700 intra-oral scanner, the Hereon intra-oral scanner, and the Sirona CEREC intra-oral scanner.

With the depth registration tool affixed to the arch, the scan is taken of the arch and/or the inter-arch area. Since the depth registration tool overlays the inter-arch area, the separation between the arch segments is well defined and the scan of the inter-arch area discerns distinct features of the ridge 204 of the depth registration tool. Data relating to the ridge 204 or other definable features of the depth registration tool is determined based on the scanned dataset.

In step 1312, a three-dimensional coordinate system is applied to each digital image to locate points of features in each digital image. The unique 3D background in each digital image or scan patch can be used as noted above to determine accurately the Z position of the various points in the scan patch.

In step 1316, the scan patches are stitched together to form the composite image. In this stage of processing, the unique background of each digital image is used to accurately align and consolidate the various digital images to form the composite image. This can be done using one or more common objects, such as a portion of a scan body 2000 or 2104 or common positive or negative feature in the central portion 324 or 1704 of the tool 100 or 1700 that appears in the adjacent scan patches. In some embodiments, corresponding software for the scanner captures all images from the scanner in real-time, generates the three-dimensional model of the area of interest, and sends the dataset to the computer.

In optional step 1320, the dimensions of the connecting area 610 are determined based on the data relating to the definable features in the depth registration tool. Data relating to the features of the depth registration tool on the connecting area is determined based on the dataset from the scan. The dimensions of the captured objects in the depth registration tool are compared with the recorded inputs of their known dimensions to determine error correction information. The error correction information is incorporated into data inputs from the scan to produce a corrected scan dataset. A determination of the dimensions of features of the arch, such as edentulous areas and teeth may be determined from the corrected scan dataset. The dimensions of the connecting area may be determined based on the data relating to the features of the connecting-geometry tool from the corrected dataset.

In some embodiments, the error correction is applied on a frame-by-frame basis due to different types and amounts of errors during scanning. For example, the handheld scanning device will have slight differences in movement, orientation, and positioning relative to the connecting area as the scanning device is moved relative to the arch area. While common error correction can be applied to each frame based on the assumption that the error is common to all frames, this assumption is frequently flawed. Subsets of frames will, due to human control of the positioning and orientation of the intra-oral scanner, have different types and/or amounts of errors to be corrected. Using common error correction across all frames can cause overcorrection of errors in some frames and leave substantial frame-specific errors in other frames uncorrected. To increase accuracy, some embodiments determine error correction factors for each subset of frames (which may be one or more frames) in the scan dataset. Thus, different error correction factors or error correction adjustments will be applied to each subset of frames.

A complete dataset of the arch area and connecting geometry is then output for further processing, such as for determining dimensions of the arch area 600 for purposes of model arch model 1216 construction. A determination of the dimensions of features of the arch 602, such as edentulous areas and teeth, may be determined from the corrected scan dataset (optional step 1324). The dimensions of the connecting area 610 may be determined based on the data relating to the features of the connecting-geometry tool from the corrected dataset (optional step 1328). The resulting dataset may be used to create an accurate model of the arch 602 and the connecting area 610 for implant installation and/or restoration processes.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22nm Haswell, Intel® Core® i5-3570K 22nm Ivy Bridge, the AMD® FX™ family of processors, AMD® FX-4300, FX-6300, and FX-8350 32nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

The exemplary systems and methods of this disclosure have been described in relation to dental restoration digital workflows. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated that the components of the system can be combined in to one or more devices, such as a server, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users'premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method of imaging a soft tissue, homogeneous, cross-arch connecting area extending between a dental arch area, the dental arch area comprising opposing first and second segments separated by the soft tissue, homogenous, cross-arch connecting area, the method comprising:
receiving an intra-oral scanned dataset comprising adjacent first and second scan patches, the adjacent first and second scan patches comprising scanned images of adjacent portions of a depth registration tool engaging first and second dental fixtures positioned on the first and second segments, respectively, of the dental arch area and overlaying the soft tissue, homogeneous, cross-arch connecting area, the first and second scan patches having different background images of one or more raised features on the depth registration tool;
identifying at least one raised feature of the one or more raised features common to the first and second scan patches; and
aligning, based on the identified at least one raised feature, the first and second scan patches to form a composite digital image.

2. The method of claim 1, wherein the one or more raised features are adjacent to and elevated above one or more unraised features of the depth registration tool, scanned images of the one or more unraised features also appearing in the first and second scan patches, and wherein upper surfaces of the raised features in the first and second scan patches are substantially coplanar.

3. The method of claim 2, wherein an area of each of the first and second scan patches is defined by a field of view of an intra-oral scanner generating the scanned dataset, wherein the one or more raised features are adjacent to a scan body, the scan body comprising an elongated arm extending outwardly from an upper scan body, an image of an upper surface of the elongated arm appearing in the first and second scan patches, the upper surface, relative to a depth of view of the intra-oral scanner, being proximal to the one or more raised features but not to the one or more unraised features.

4. The method of claim 1, wherein the first scan patch comprises a scan of a first raised feature not appearing in the second scan patch, wherein the second scan patch comprises a scan of a second raised feature not appearing in the first scan patch, the first and second raised features having at least one of a different spatial relationship to an adjacent raised feature, different dimension and different degree of curvature.

5. The method of claim 1, further comprising:
determining data relating to the identified at least one raised feature; and
determining dimensions of the soft tissue, homogeneous, cross-arch connecting area based on the data relating to the identified at least one raised feature.

6. The method of claim 5, wherein determining dimensions comprises performing an error assessment to determine a skew between a known dimension of the identified at least one raised feature and a corresponding dimension of the identified at least one raised feature determined from the data relating to the identified at least raised feature.

7. The method of claim 1, wherein the dental fixture comprises one of a dental implant, abutment, and scan body, wherein the depth registration tool comprises first and second apertures for receiving the first and second dental fixtures, wherein each of the first and second apertures communicates with a corresponding transverse cutout to enable the aperture to receive the corresponding one of the first and second apertures, wherein a central portion of the depth registration tool blocks imaging of an underlying portion of the soft tissue, homogenous, cross-arch connecting area, and further comprising:
receiving a second intra-oral scanned dataset comprising an image of the underlying portion of the soft tissue, homogenous, cross-arch connecting area;
generating a virtual three-dimensional model of the cross-arch area and underlying portion of the soft tissue, homogenous, cross-arch connecting area and
removing, in the virtual three-dimensional model, an image of the depth registration tool to display the underlying portion of the soft tissue, homogenous, cross-arch connecting area.

8. A computational system comprising a processor and computer readable medium comprising instructions that, when executed, cause the processor to:
receive an intra-oral scanned dataset comprising adjacent first and second scan patches, the adjacent first and second scan patches comprising scanned images of adjacent portions of a depth registration tool engaging first and second dental fixtures positioned on first and second segments, respectively, of a dental arch area and overlaying a soft tissue, homogeneous, cross-arch connecting area between the first and second segments, the first and second scan patches having different background images of one or more raised features on the depth registration tool;
identify at least one raised feature of the one or more raised features common to the first and second scan patches; and
align, based on the identified at least one raised feature, the first and second scan patches to form a composite digital image.

9. The computational system of claim 8, wherein the one or more raised features raised features are each adjacent to and elevated above one or more raised features unraised features of the depth registration tool, scanned images of the one or more raised features unraised features also appearing in the first and second scan patches, and wherein upper surfaces of the one or more raised features raised features in the first and second scan patches are substantially coplanar.

10. The computational system of claim 9, wherein an area of each of the first and second scan patches is defined by a field of view of an intra-oral scanner generating the scanned dataset, wherein the one or more raised features raised features are adjacent to a scan body, the scan body comprising an elongated arm extending outwardly from an upper scan body, an image of an upper surface of the elongated arm appearing in the first and second scan patches, the upper surface, relative to a depth of view of the intra-oral scanner, being proximal to the one or more raised features raised features but not to the one or more raised features unraised features.

11. The computational system of claim 8, wherein the first scan patch comprises a scan of a first raised feature not appearing in the second scan patch, wherein the second scan patch comprises a scan of a second raised feature not appearing in the first scan patch, the first and second raised features having at least one of a different spatial relationship to an adjacent raised feature, different dimension and different degree of curvature.

12. The computational system of claim 8, wherein the processor:
determines data relating to the identified at least one raised feature; and
determines dimensions of the soft tissue, homogeneous, cross-arch connecting area based on the data relating to the identified at least one raised feature.

13. The computational system of claim 12, wherein determining dimensions comprises the processor performing an error assessment to determine a skew between a known dimension of the identified at least one raised feature and a corresponding dimension of the identified at least one raised feature determined from the data relating to the identified at least raised feature.

14. The computational system of claim 8, wherein the dental fixture comprises one of a dental implant, abutment, and scan body, wherein the depth registration tool comprises first and second apertures for receiving the first and second dental fixtures, wherein each of the first and second apertures communicates with a corresponding transverse cutout to enable the aperture to receive the corresponding one of the first and second apertures, wherein a central portion of the depth registration tool blocks imaging of an underlying portion of the soft tissue, homogenous, cross-arch connecting area, and wherein the processor:
receives a second intra-oral scanned dataset comprising an image of the underlying portion of the soft tissue, homogenous, cross-arch connecting area;
generates a virtual three-dimensional model of the cross-arch area and underlying portion of the soft tissue, homogenous, cross-arch connecting area and
removes, in the virtual three-dimensional model, an image of the depth registration tool to display the underlying portion of the soft tissue, homogenous, cross-arch connecting area.

15. A depth registration tool for intra-oral scanning comprising:
a plurality of attachment locations distributed around a peripheral edge of the tool and configured to attach to a plurality of dental fixtures positioned on first and second segments, respectively, of a dental arch area; and
a central area configured to overlay a soft tissue, homogeneous, cross-arch connecting area between the first and second segments and comprising a plurality of non-uniformly distributed elevated objects, the non-uniformly distributed elevated objects comprising upper surfaces elevated relative to an adjacent surface of the central area, the central area blocking scanning of at least most of the soft tissue, homogeneous, cross-arch connecting area between the first and second segments.

16. The depth registration tool of claim 15, wherein each of the plurality of attachment locations comprises an aperture and transverse cut out extending into the central area from the corresponding aperture, the aperture configured to receive a respective dental fixture of the plurality of dental fixtures.

17. The depth registration tool of claim 15, wherein the plurality of non-uniformly distributed elevated objects comprises a plurality of plurality of elevated segments of a discontinuous arcuate ridge.

18. The depth registration tool of claim 15, further comprising from about 10 to about 60% reflective beads to reflect light from an ultrasound scanner away from the tool and underlying soft tissue, homogeneous, cross-arch connecting area between the first and second segments.

19. The depth registration tool of claim 15, wherein the plurality of dental fixtures comprise a plurality of scan bodies, each scan body comprising an upper scan body positioned above a base and an elongated arm extending outwardly from the base and positioned over an adjacent portion of the depth registration tool.

20. The depth registration tool of claim 19, wherein a longitudinal axis of the elongated arm is substantially aligned with the first segment of the dental arch area and transverse to the soft tissue, homogeneous, cross-arch connecting area.

21. A computer readable medium comprising instructions that, when executed, perform the steps of claim 1.

22. A scan body for intra-oral scanning comprising:
a base configured to attach to a dental fixture;
an upper scan body extending upwardly from the base, the upper scan body comprising a leading surface and a trailing surface, the leading surface having a different shape than the trailing surface, and one or more information markers; and
first and second elongated arms positioned between the base and upper scan body, the first elongated arm extending anteriorly from the leading surface and the second elongated arm extending posteriorly from the trailing surface.

23. The scan body of claim 22, wherein the first and second elongated arms extend different distances outwardly from the upper scan body and comprise one or more surface irregularities for shape matching against a virtual counterpart of the scan body.

24. The scan body of claim 22, wherein upper and/or lower surfaces of one or both of the first and second elongated arms is convex or concave in curvature.
